(19) United States
(12) Patent Application Publication
(10) Pub. No.: US 2026/0113707 A1
(43) Pub. Date: Apr. 23, 2026

(54) NETWORK WAKEUP COORDINATION

(71) Applicant: Apple Inc., Cupertino, CA (US)

(72) Inventors: Venkateswara Rao MANEPALLI, San Jose, CA (US); Arun Vijayakumari MAHASENAN, Fremont, CA (US)

(21) Appl. No.: 19/295,515

(22) Filed: Aug. 8, 2025

Related U.S. Application Data
(60) Provisional application No. 63/708,687, filed on Oct. 17, 2024.

(51) Int. Cl. H04W 52/02; H04W 76/15

(52) U.S. Cl. CPC H04W 52/0229; H04W 76/15

(57) ABSTRACT

The subject technology provides for network wakeup coordination. In one or more implementations, network wakeup coordination may include determining, by a router that is one of multiple routers in a mesh network responsive to a trigger event, that multiple sleepy end devices of the mesh network are in a sleep state. The network wakeup coordination may also include generating a wakeup frame to be asynchronously provided by the router, in coordination with at least one other router of the multiple routers, to a set of the sleepy end devices.

### CROSS REFERENCE TO RELATED APPLICATIONS

This application claims the benefit of priority to U.S. Provisional Patent Application No.63/708,687, entitled, “Network Wakeup Coordination”, filed on October 17, 2024, the disclosure of which is hereby incorporated herein in its entirety.

### TECHNICAL FIELD

The present description generally relates to wireless communication systems and, in particular to, network wakeup coordination.

### BACKGROUND

A mesh network may include router devices to forward packets between end devices of the network. That is, the end devices communicate with a corresponding router of the network but may not forward packets for other network devices. In this way, the router may act as a parent device for the end devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates a block diagram of an example system for mesh network communication in accordance with one or more implementations.

FIG. 3 illustrates an example of a mesh network following an outage in accordance with one or more implementations.

FIG. 4 is a timing diagram illustrating example operations that may be performed for network wakeup coordination in accordance with one or more implementations.

FIG. 5 is a timing diagram illustrating other example operations that may be performed for network wakeup coordination in accordance with one or more implementations.

FIG. 6 is a flow chart of an example process that may be performed for network wakeup coordination in accordance with one or more implementations.

FIG. 7 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the present disclosure relate to enabling communication between devices of a network. In one or more implementations, the network may include a mesh network, and communication between devices on the network may be performed in accordance with a mesh network communication protocol for the mesh network. In one or more implementations, the mesh network communication protocol may be a Thread® network protocol, as defined in Thread 1.3.0 Specification. However, the disclosed subject matter is applicable to any networking environment.

In one or more implementations, a mesh network may include devices, such as routers and end devices. End devices may include sleepy end devices (SEDs), which are normally disabled (e.g., asleep) and wake on occasion to poll for messages from a parent device (e.g., the router). In this regard, SEDs can include battery-powered accessories that exhibit intermittent radio functionality due to resource or battery constraints. In one or more implementations, an SED may awaken when a “wakeup message” is received. For example, a router may transmit the wakeup message to the SED. The wakeup message may instruct the SED to wake up to poll for messages at a time different than a scheduled polling period for the SED. In one or more implementations, the end devices may continue to operate as SEDs and use coordinated sampled listening (CSL) techniques to communicate (e.g., via the mesh network communication protocol).

Sleepy end devices may have dynamic wakeup polling periods. For example, when no response to a polling message is received at the sleepy end device, the sleepy end device may increase the time between polling wakeups. In some operational scenarios, the increased time between polling wakeups can reach periods of minutes or several minutes (e.g., up to ten minutes or twenty minutes). In some operational scenarios, a sleepy end device may become detached from the mesh network. For example, these operational scenarios can occur following network outage events (e.g., due to a router device reboot, a software update at a router, or a power outage event) and/or other scenarios in which one or more sleepy end devices enter a prolonged sleep state or a detached state. Following these events or scenarios in which a sleepy end device enters a prolonged sleep state or a detached state, it can be disruptive or inconvenient to the mesh network and/or a user thereof to wait for minutes (e.g., up to ten minutes or twenty minutes) for the SED to wake up and rejoin the mesh network. As one example of another scenario in which it can be disruptive or inconvenient to delay waking sleepy end devices after the sleepy end devices enter a prolonged sleep state or a detached state, a mesh network may include a network of security sensors (e.g., cameras, motion sensors, or the like) configured for monitoring a perimeter of a geographical area. In a use case in which one of the security sensors detects a potential intrusion of the perimeter, it may be desirable for that sensor to efficiently trigger a wakeup of one or more nearby security sensors to aid in monitoring, confirming, and/or classifying the potential intrusion.

Aspects of the subject technology can help to reduce the time to return sleepy end devices (SEDs) to a mesh network following a trigger event (e.g., a network outage or an event detection by a sensor) that causes the sleepy end devices to stop polling for long periods of time (e.g., as much as ten or twenty minutes) and/or to become detached. This reduction can be beneficial, for example, after a network outage, a router reboot, or a power outage, that results in multiple SEDs concurrently being in a prolonged sleep mode or detached state.

In order, for example, to efficiently return the sleepy end devices to the mesh network, while avoiding collision of wakeup frames from multiple routers, a coordinated network wide wakeup operation may be performed. The network wide wakeup operation may include multiple routers in the mesh network asynchronously sending one or more wakeup frames to the sleepy end devices of the network. In order, for example, to reduce or avoid collisions, the multiple routers may perform an unscheduled wakeup operation (e.g., in which each router establishes a different random jitter for sending out the wakeup frames), or a scheduled wakeup operation (e.g., in which the multiple routers send out wakeup frames in a router order as determined by a wakeup schedule generated by a coordinator, such as a leader of the mesh network).

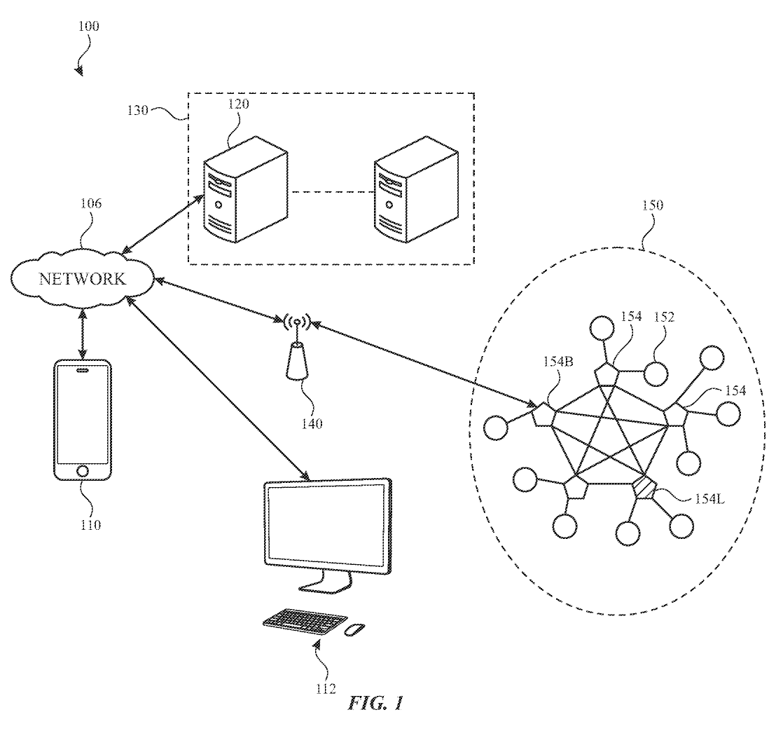

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100, which may operate in conjunction with the IEEE 802.15.4 standards for low-rate wireless personal area networks (LR-WPANs). It is understood that the concepts disclosed herein may also be applied to other networks, including Thread®, Zigbee®, Z-Wave®, Bluetooth Low Energy (BLE), ISA100.11a, WirelessHART®, MiWi™, IPv6 over Low-Power Wireless Personal Area Networks (6LoWPAN), Subnetwork Access Protocol (SNAP), Wi-Fi mesh networks, and the like.

In the example of FIG. 1, the network environment 100 includes an electronic device 110, an electronic device 112, a server 120, an access point 140 and a mesh network 150. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

The electronic device 110 may be, for example, a desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 7.

The electronic device 112 may be, for example, desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 112 is depicted as a desktop computer. The electronic device 112 may be, and/or may include all or part of, the electronic system discussed below with respect to FIG. 7.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users. Although the electronic device 110 and the electronic device 112 are depicted as being outside the mesh network 150, in various use cases, and/or at various times, the electronic device 110 and/or the electronic device 112 may be included in the mesh network 150.

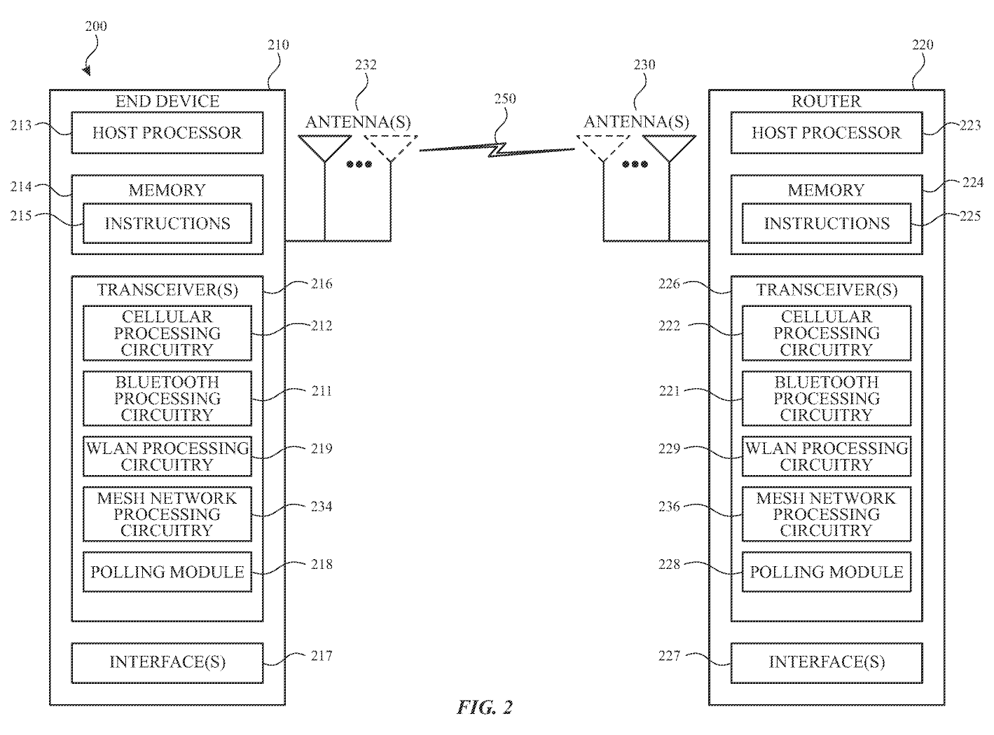

In the example of FIG. 1, the mesh network 150 includes various end devices 152 and routers 154 (each of which may include any one of the electronic devices 110 or 112, and/or other electronic devices). In one or more implementations, the routers 154 (represented as pentagons in the figure) may forward packets (e.g., data) between and/or to the end devices 152 (represented as circles in the figure) of the mesh network 150. In some use cases, a router 154 may transmit a packet via a radio or transceiver, such as the transceiver 226 of FIG. 2, to a targeted end device 152 via another router 154. The routers 154 may also provide secure commissioning services for other devices attempting to join the mesh network 150. The transceiver 226 of each router 154 may be enabled at times for a specified duration to receive and transmit packets.

In one or more implementations, the end devices 152 and the routers 154 may communicate according to a mesh network communication protocol (e.g., a Thread® network protocol) for the mesh network 150. For example, the mesh network communication protocol may govern how a device acting as a router 154 forwards packets between end devices 152 of the mesh network 150. In one or more implementations, each device acting as a router 154 may act as a parent device for one or more of the end devices 152. The parent device may provide connectivity for, and manage communication with, the end devices that are child devices of that parent device. As such, an end device 152 may utilize a radio thereof to transmit a message to another end device 152, e.g., over the mesh network 150, via at least its parent router 154. As shown in FIG. 1, a mesh network, such as mesh network 150, may include multiple devices acting as routers 154. Devices that may act as routers 154 in the mesh network 150 may include devices that are specifically implemented (e.g., in hardware) as routers, and/or router-eligible end devices that can act as end devices and can perform router operations for other end devices.

Each end device 152 of the mesh network 150 may communicate primarily with a single router 154, which may be referred to as a parent (or parent device) of that end device 152. For example, the end devices 152 may not forward packets for other network devices (e.g., end devices 152 and router 154).

As discussed herein, in various implementations and/or use cases, the roles of various devices in the mesh network 150 may be dynamic. For example, if a router 154 does not have any child devices (e.g., communicatively coupled end devices 152), the router 154 may be downgraded and/or configured to operate as an end device 152. In another example, if a new end device attempting to join the mesh network 150 is within range of a current end device 152 of the mesh network 150 (but not a router 154), and that end device 152 is eligible to become a router 154 (e.g., is a router-eligible end device), that end device 152 may be upgraded and/or configured to operate as a router 154 for the new end device 152. In that case, the new router 154 acts as a router 154 with respect to the new end device and may be communicatively coupled to one or more other routers 154 of the mesh network 150.

In one or more implementations, one or more of the end devices 152 may be sleepy end devices (SEDs) and may occasionally or periodically disable their respective transceivers (e.g., in the form of the transceiver 216 of FIG. 2) to reduce power consumption. In such cases, the end devices 152 serving as SEDs may wake on occasion to poll for messages from a corresponding router 154. An interval between polling by an end device 152 may be based on a schedule or other configuration of a corresponding transceiver (e.g., the transceiver 216 of FIG. 2), and may be controlled by a processor, such as the host processor 213 of FIG. 2, the mesh network processing circuitry 234 of FIG. 2, and/or a power management unit (PMU) of the end device 152. In one or more implementations, the interval between polling by the end device 152 may increase with time when no response to the polling is received. In one or more implementations, a sleepy end device may continue to (e.g., periodically) listen for a wakeup message, even in a state in which polling is inactive or suspended. In this way, the sleepy end devices may be able to receive a wakeup frame from another device (e.g. a router 154) even in a prolonged sleep state or a detached state.

In one or more implementations, wakeup frames may be transmitted in a wakeup channel which is separate from a current operating channel. In one or more implementations, the wakeup channel may be added as a parameter to the mesh network operational dataset and configured on the nodes of the mesh network 150 via commissioning procedures. In one or more implementations, a wakeup frame may be a multipurpose frame with a rendezvous time IE which is set to zero. In one or more implementations, a wakeup frame may include a dataset information, such as Active Dataset timestamp.

In one or more implementations, a router 154 (e.g., including the leader 154L) may act as a parent device for an end device 152 serving as a SED, such as by buffering incoming data while the SED is in a sleep state. This procedure involves a downlink message to the SED, where the router 154 buffers the data until the SED awakens and queries for the data, known as the polling procedure. The SED then keeps its receiver (e.g., receiver portion of the transceiver 216 of FIG. 2) active for a specified duration to receive the incoming data.

Examples of devices that can operate as end devices 152 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device. Some or all of the end devices 152 may be referred to as Internet-of-Things (IoT) devices. Some or all of the end devices 152 may have the capability of acting as a router 154, some of the end devices 152 may not have the capability of acting as routers, and/or some of the routers 154 may be specifically implemented (e.g., in hardware) as routers and may not have the capability of acting as an end device. As examples, the routers 154 may be implemented as routers or router-enable end devices (REEDs) that can act as routers or end devices. Examples of REEDs include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device with the capability (e.g., hardware and software capabilities) of acting as a router (e.g., forwarding packets for other devices).

In one or more implementations, a router 154 of the mesh network 150 may perform leader role for the mesh network 150. For example, the mesh network 150 of FIG. 1 includes a router 154 that serves as a leader 154L (e.g., a leader node) in the mesh network 150. For example, the leader 154L may perform a leader role in the mesh network. In one or more implementations, performing the leader role may include managing the overall network structure and operation of the mesh network 150, including initialization, synchronization, and topological control. Performing the leader role may include aggregating and distributing network-wide confirmation information to the other routers 154 and the end devices 152 of the mesh network 150. Performing the leader role may include determining whether a router-eligible end device (REED) acting as an end device 152 in the mesh network 150 is authorized to upgrade to act as a router 154 in the mesh network 150, and/or determining whether a REED acting as a router 154 in the mesh network 150 is authorized to downgrade to act as an end device 152 in the mesh network 150.

In one or more implementations, a router 154 of the mesh network 150 may forward information between the mesh network and a non-mesh network, such as a Wi-Fi network. For example, the border router 154B may forward information between the mesh network 150 and a non-mesh network, such as the network 106, such as through the access point 140. In that case, the router may be referred to as a border router 154B, and may convert a Wi-Fi message to the mesh network communication protocol and transmit the converted mesh network message to a target end device 152 for the message using a mesh network radio. For explanatory purposes, only the router 154B is illustrated as being connected to the access point 140, however, it is appreciated that the mesh network 150 may include more than one border router (e.g., one or more of the other routers 154 may also be configured to act as a border router 154B) connected to the access point 140 in some implementations.

FIG. 2 illustrates a block diagram of an example of a system 200 including an end device and a router of a mesh network in accordance with one or more implementations. The system 200 may be a portion of the network environment 100. The end device 210 may be, for example, one of the end devices 152 of the mesh network 150. The router 220 may be, for example, one of the routers 154 of the mesh network 150.

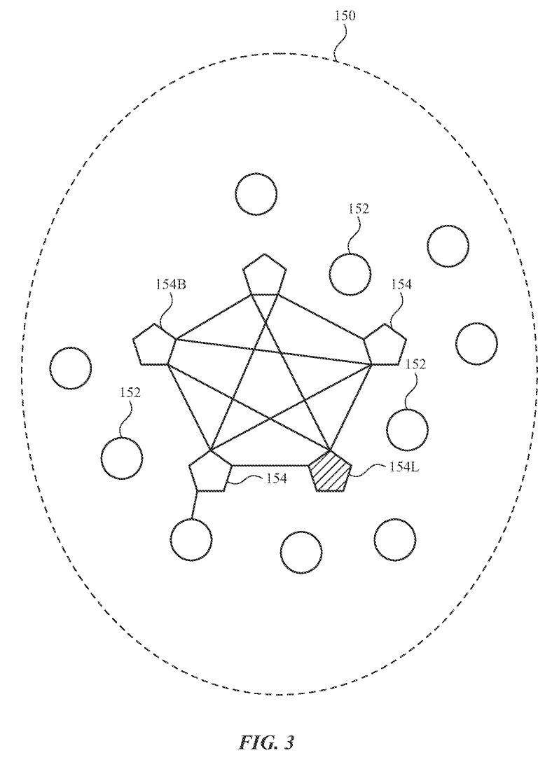

As shown in FIG. 2, the end device 210 may include a host processor 213. The host processor 213 may execute instructions such that various operations of the end device 210 are performed. For example, the host processor 213 can serve as the CPU responsible for executing instructions and managing various tasks, such as the operations described herein in connection with FIGS. 3-6. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The end device 210 may include one or more transceiver(s) 216 that may include radio frequency (RF) transmitter and/or receiver circuitry that uses the antenna(s) 232 of the end device 210 to facilitate signaling (e.g., the signaling 250) to and/or from the end device 210 with other devices (e.g., the router 220) according to corresponding wireless communication protocols (e.g., Thread, cellular, Wi-Fi, Bluetooth). The one or more transceivers 216 can be responsible for both transmitting and receiving radio signals. The one or more transceivers 216 can facilitate wireless communication by converting digital data into radio waves for transmission and then converting received radio waves back into digital data for the end device 210 to process. The one or more transceivers 216 can operate within specific frequency bands allocated for wireless communication and may employ various modulation techniques to optimize data transmission efficiency and reliability. In one or more implementations, the one or more transceiver(s) 216 are not limited to specific wireless communication protocols, including Bluetooth, Thread®, Wi-Fi, cellular, among others, as it is appreciated that other wireless communication protocols and/or technologies can be associated with the one or more transceiver(s) 216.

The end device 210 may include memory 214. The memory 214 may include a non-transitory computer-readable storage medium that stores instructions 215 (which may include, for example, the instructions being executed by one or more components in the transceiver 216 and/or the host processor 213). The instructions 215 may also be referred to as program code or a computer program. The memory 224 may also store data used by, and results computed by, the transceiver 216 and/or the host processor 213.

The end device 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the RF components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the end device 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The end device 210 may include Bluetooth processing circuitry 211. The Bluetooth processing circuitry 211 is responsible for managing the transmission and reception of wireless signals to and from mobile devices (e.g., end device 210) for Bluetooth communication. The Bluetooth processing circuitry 211 can perform various signal processing tasks related to modulation, demodulation, encoding, decoding, and error correction to ensure reliable communication over the air interface. The Bluetooth processing circuitry 211 may execute instructions such that various operations of the end device 210 are performed, as described herein. The Bluetooth processing circuitry 211 may include one or more baseband processors implemented using, for example, a CPU, a DSP, an ASIC, a controller, an FPGA device, another hardware device, a firmware device, or any combination thereof configured to perform the operations described herein.

The end device 210 may include WLAN processing circuitry 219. The WLAN processing circuitry 219 is responsible for managing the transmission and reception of wireless signals to and from mobile devices (e.g., end device 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the end device 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein.

The end device 210 may include mesh network processing circuitry 234. The mesh network processing circuitry 234 is responsible for managing the transmission and reception of wireless signals to and from mobile devices (e.g., end device 210) for mesh network communication. The mesh network processing circuitry 234 can perform various signal processing tasks related to modulation, demodulation, encoding, decoding, and error correction to ensure reliable communication over the air interface. The mesh network processing circuitry 234 may execute instructions such that various operations of the end device 210 are performed, as described herein. The mesh network processing circuitry 234 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the mesh network processing circuitry 234 to facilitate mesh network communication. The one or more transceivers 216 may be responsible for converting digital data from the mesh network processing circuitry 234 into radio signals for transmission over the air and for receiving incoming radio signals, which are then converted back into digital data for processing by the mesh network processing circuitry 234. This collaboration enables the end device 210 to transmit and receive data, supporting functions such as voice calls, text messaging, Internet access, and other wireless services via the mesh network 150 of FIG. 1. The mesh network processing circuitry 234 manages the digital signal processing tasks, while the one or more transceivers 216 handle the analog RF operations, working together to enable wireless communication capabilities in the end device 210.

The end device 210 may include one or more antenna(s) 232 (e.g., one, two, four, or more). In implementations having multiple antenna(s) 230, the router 220 may perform multiple-in-multiple-out (MIMO), digital beamforming, analog beamforming, beam steering, etc. For implementations with multiple antenna(s) 232, the end device 210 may leverage the spatial diversity of such multiple antenna(s) 232 to send and/or receive multiple different data streams on the same time and frequency resources.

The end device 210 may include one or more interface(s) 217. The interface(s) 217 may be used to provide input to or output from the end device 210. For example, an end device 210 that is a UE may include interface(s) 217 such as microphones, speakers, a touchscreen, buttons, and the like to allow for input and/or output to the UE by a user of the UE. Other interfaces of such a UE may be made up of transmitters, receivers, and other circuitry (e.g., other than the transceiver(s) 216/antenna(s) 232 already described) that allow for communication between the UE and other devices and may operate according to known protocols (e.g., Wi-Fi®, Bluetooth®, and the like).

The end device 210 may include polling block 218. The polling block 218 may be implemented via hardware, software, or combinations thereof. For example, the polling block 218 may be implemented as a processor, circuit, and/or instructions 215 stored in the memory 214 and executed by the host processor 213 and/or the transceiver 216. In some examples, the polling block 218 may be integrated within the transceiver(s) 216. For example, the polling block 218 may be implemented by a combination of software components (e.g., executed by a DSP or a general processor) and hardware components (e.g., logic gates and circuitry) within the transceiver(s) 216. In other examples, the polling block 218 is a separate component from the transceiver(s) 216.

The router 220 may include a host processor 223. The host processor 223 may execute instructions such that various operations of the router 220 are performed. For example, the host processor 223 can serve as the central processing unit (CPU) responsible for executing instructions and managing various tasks, such as one or more of the operations described herein in connection with FIGS. 3-6. The host processor 223 can include multiple cores, each capable of handling multiple threads simultaneously, enabling multitasking. The host processor 223 can integrate various components such as ALUs, registers, cache memory, and control units to execute instructions and process data. Additionally, the host processor 223 can include integrated DSPs, GPUs, NPUs, and hardware accelerators. The host processor 223 may be implemented using, for example, an ASIC, a controller, a FPGA device, another hardware device, a firmware device, or any combination thereof configured to perform the operations described herein.

The router 220 may include one or more transceiver(s) 226 that may include RF transmitter and/or receiver circuitry that use antenna(s) 230 of the router 220 to facilitate signaling (e.g., the signaling 250) to and/or from the router 220 with other devices (e.g., the end device 210) according to corresponding wireless communication protocols (e.g., cellular, Wi-Fi, Bluetooth). The one or more transceivers 226 can be responsible for both transmitting and receiving radio signals. The one or more transceivers 226 can facilitate wireless communication by converting digital data into radio waves for transmission and then converting received radio waves back into digital data for the router 220 to process. The one or more transceivers 226 can operate within specific frequency bands allocated for wireless communication and may employ various modulation techniques to optimize data transmission efficiency and reliability. In one or more implementations, the one or more transceiver(s) 226 are not limited to specific wireless communication protocols, including Bluetooth, Thread®, Wi-Fi, cellular, among others, as it is appreciated that other wireless communication protocols and/or technologies can be associated with the one or more transceiver(s) 226.

The router 220 may include memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the transceiver 226 and/or the host processor 223.

The router 220 may include cellular processing circuitry 222. The cellular processing circuitry 222 is responsible for managing the transmission and reception of wireless signals to and from mobile devices (e.g., end device 210). The cellular processing circuitry 222 can perform various signal processing tasks related to modulation, demodulation, encoding, decoding, and error correction to ensure reliable communication over the air interface. The cellular processing circuitry 222 may execute instructions such that various operations of the router 220 are performed, as described herein. The cellular processing circuitry 222 may include one or more baseband processors implemented using, for example, a CPU, a DSP, an ASIC, a controller, an FPGA device, another hardware device, a firmware device, or any combination thereof configured to perform the operations described herein.

The router 220 may include Bluetooth processing circuitry 221. The Bluetooth processing circuitry 221 is responsible for managing the transmission and reception of wireless signals to and from mobile devices (e.g., end device 210) for Bluetooth communication. The Bluetooth processing circuitry 221 can perform various signal processing tasks related to modulation, demodulation, encoding, decoding, and error correction to ensure reliable communication over the air interface. The Bluetooth processing circuitry 221 may execute instructions such that various operations of the router 220 are performed, as described herein. The Bluetooth processing circuitry 221 may include one or more processors implemented using, for example, a CPU, a DSP, an ASIC, a controller, an FPGA device, another hardware device, a firmware device, or any combination thereof configured to perform the operations described herein.

The router 220 may include WLAN processing circuitry 229. The WLAN processing circuitry 229 is responsible for managing the transmission and reception of wireless signals to and from mobile devices (e.g., end device 210) for Wi-Fi communication. The WLAN processing circuitry 229 can perform various signal processing tasks related to modulation, demodulation, encoding, decoding, and error correction to ensure reliable communication over the air interface. The WLAN processing circuitry 229 may execute instructions such that various operations of the router 220 are performed, as described herein. The WLAN processing circuitry 229 may include one or more processors implemented using, for example, a CPU, a DSP, an ASIC, a controller, an FPGA device, another hardware device, a firmware device, or any combination thereof configured to perform the operations described herein.

The router 220 may include mesh network processing circuitry 236. The mesh network processing circuitry 236 is responsible for managing the transmission and reception of wireless signals to and from mobile devices (e.g., end device 210) for mesh network communication. The mesh network processing circuitry 236 can perform various signal processing tasks related to modulation, demodulation, encoding, decoding, and error correction to ensure reliable communication over the air interface. The mesh network processing circuitry 236 may execute instructions such that various operations of the router 220 are performed, as described herein. The mesh network processing circuitry 236 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the mesh network processing circuitry 236 to facilitate mesh network communication. The one or more transceivers 226 is responsible for converting digital data from the mesh network processing circuitry 236 into radio signals for transmission over the air and for receiving incoming radio signals, which are then converted back into digital data for processing by the mesh network processing circuitry 236. This collaboration enables the router 220 to transmit and receive data, supporting functions such as audio services, Internet access, and other wireless services via the mesh network 150 of FIG. 1. The mesh network processing circuitry 236 manages the digital signal processing tasks, while the one or more transceivers 226 handle the analog RF operations, working together to enable wireless communication capabilities in the router 220.

The router 220 may include one or more antenna(s) 230 (e.g., one, two, four, or more). In implementations having multiple antenna(s) 230, the router 220 may perform multiple-in-multiple-out (MIMO), digital beamforming, analog beamforming, beam steering, etc.

The router 220 may include one or more interface(s) 227. The interface(s) 227 may be used to provide input to or output from the router 220. For example, a router 220 may include interface(s) 227 made up of transmitters, receivers, and other circuitry (e.g., other than the transceiver(s) 226/antenna(s) 230 already described) that enables the router 220 to communicate with other equipment in the mesh network 150, and/or that enables the router 220 to communicate with external networks, computers, databases, and the like for purposes of operations, administration, and maintenance of the router 220 or other equipment operably connected thereto.

The router 220 may include a polling block 228. The polling block 228 may be implemented via hardware, software, or combinations thereof. For example, the polling block 228 may be implemented as a processor, circuit, and/or instructions 225 stored in the memory 224 and executed by one or more components in the transceiver 226. In some examples, the polling block 228 may be integrated within the transceiver(s) 226. For example, the polling block 228 may be implemented by a combination of software components (e.g., executed by a DSP or a general processor) and hardware components (e.g., logic gates and circuitry) within the transceiver(s) 226. In other examples, the polling block 228 is a separate component from the transceiver(s) 226.

In one or more implementations, multiple wireless communication protocols (e.g., mesh network and Bluetooth technologies) may coexist in an electronic device (e.g., electronic devices 110-112 of FIG. 1) with a shared radio that operates at 2.4 gigahertz for both Bluetooth and mesh network technologies. The integrated circuit (IC) chip responsible for modulation and demodulation, the software stack, the hardware stack, and the antennas for transmission and reception may all be shared resources between the Bluetooth and mesh network technologies. In one or more implementations, when the mesh network processing circuitry 234 is active, the Bluetooth processing circuitry 211 may not be active, and vice versa, resulting in time division multiplexing between the Bluetooth and mesh network technologies.

In one or more implementations, a network outage can occur (e.g., due to a device reboot, a software update, or power outage event) in some or all of the mesh network 150. For example, FIG. 3 illustrates a block diagram of the mesh network 150 a state, following a network-wide outage, in which the routers 154 have restored communication therebetween, but some or all of the end devices 152 have entered a prolonged sleep state or a detached state in which the end devices 152 are not waking to perform polling (at least for a period of time). In the example of FIG. 3, the end devices 152 may continue to periodically listen for a wakeup frame from one or more of the routers 154, even if the end devices 152 are not polling for extended periods of time. Although the example of FIG. 3 is described herein in connection with recovery from an outage, the network configuration of FIG. 3 can occur in other use cases, such as a use case in which some or all of the end devices 152 are security sensors that have entered a prolonged sleep state or a detached state, and a wakeup of some or all of those sleepy sensors is desired (e.g., if another sensor has detected an event and triggers the wakeup).

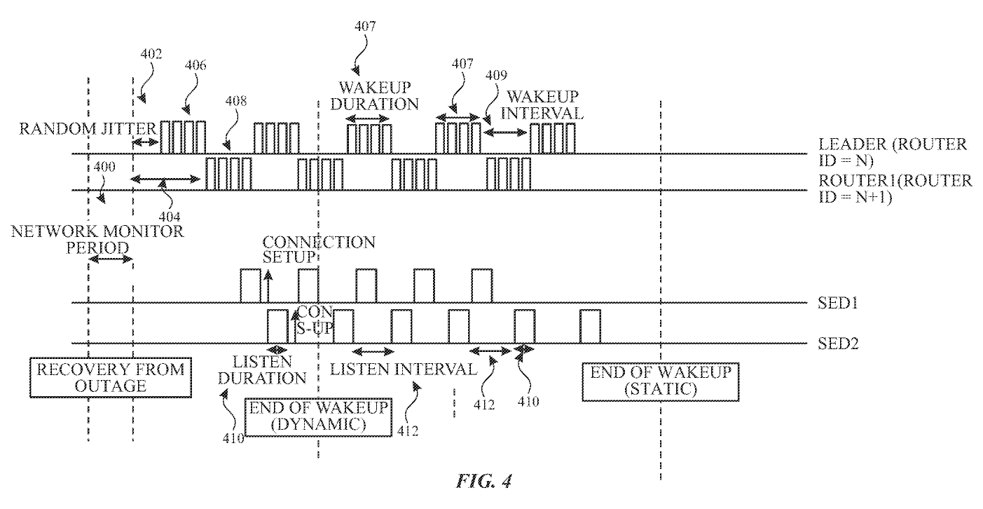

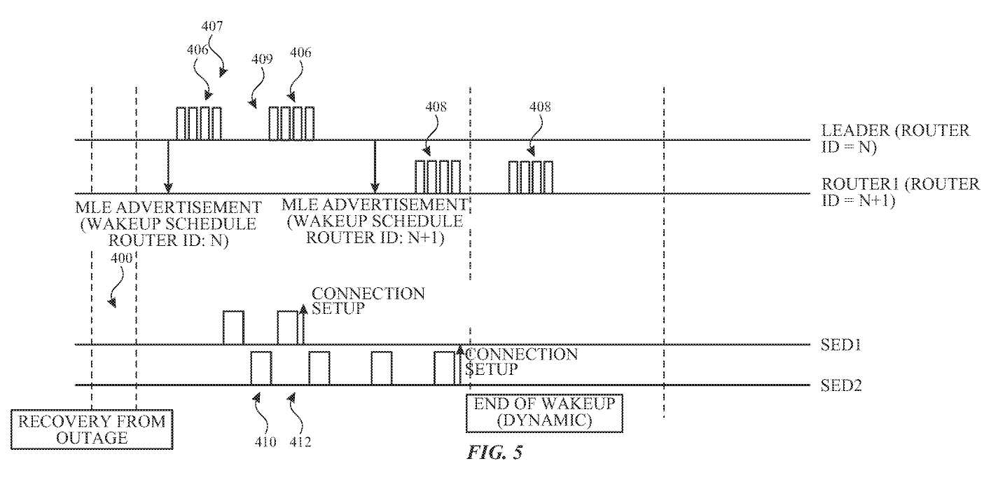

As discussed herein, it may be desirable to be able to wake up the sleepy end devices that are in the prolonged sleep state or detached state, without waiting for the completion of a current (e.g., long) interval between polling operations at the sleepy end devices. However, in, for example, an implementation in which the mesh network 150 includes multiple end devices (e.g., multiple full thread devices (FTDs)), a coordination mechanism may be provided to avoid collision of wakeup frames from multiple devices. In various examples, the coordination may be performed by a central node or coordinator, such as the leader 154L, or a resident device or controller with knowledge of (e.g., stored data indicating) all the sleepy end devices in the mesh network 150. As examples, FIGS. 4 and 5 illustrate various operations that may be performed for waking up the sleepy end devices 152 that are in the prolonged sleep state or detached state to rejoin the mesh network 150, in a coordinated manner that avoids wakeup frame collisions in the network.

For example, FIG. 4 is a timing diagram illustrating an unscheduled network wakeup coordination operation that may be performed for the mesh network 150. As shown in FIG. 4, in one or more implementations, the wakeup procedures described herein may be dynamically enabled/disabled based on network monitoring for a network monitor period 400 (e.g., a time period which may be labeled MONITOR_DURATION). For example, if all of the SEDs are reachable from the coordinating device at any time during the network monitor period 400, the wakeup procedure may not be performed or may be turned off.

In the example of FIG. 4, a first router (e.g., a router 154 with a Router ID = n, such as the leader 154L) may transmit wakeup frames 406 for a wakeup duration 407. For example, the router ID may be assigned by a coordinator device of the mesh network, such as the leader 154L or a resident device. As shown, the first router may transmit the wakeup frames 406 after a jitter time 402. In one or more implementations, the jitter time may be determined based on the router ID. As shown, the first router may repeat transmitting of the wakeup frames 406 after a wakeup interval 409 following the wakeup duration 407. As shown, a second router (e.g., another router 154 with a Router ID = n+1) may transmit wakeup frames 408 for the wakeup duration 407, after a jitter time 404 that is different from the jitter time 402 used by the first router. In this way, the wakeup frame transmission of the first router and the second router may be asynchronously transmitted (e.g., staggered), so as to reduce or minimize (or otherwise avoid) collisions of wakeup frames from multiple routers. As shown, the second router may repeat transmitting of the wakeup frames 408 after the wakeup interval 409 following the wakeup duration 407. Staggering the transmission of the wakeup frames from the multiple routers as shown may be particularly beneficial following, for example, a power outage in which all of the routers 154 may return to the mesh network 150 at or near the same time (e.g., and would otherwise attempt to transmit wakeup frames at the same time as other routers).

As shown in FIG. 4, multiple sleepy end devices (e.g., SED1 and SED2 in FIG. 4, such as SEDs that are not attached to any parent and/or are in a prolonged sleep state) may perform listening operations (e.g., on a wakeup channel) for receiving a wakeup frame with listen durations 410 (e.g., a predefined LISTEN_DURATION) separated in time by a listen interval 412 (e.g., a predefined LISTEN_INTERVAL). In one or more implementations, the wakeup duration 407 and the wakeup interval 409 define the duration and interval for which a node (e.g., a full thread device node, such as leader 154L or another router 154) will transmit the wakeup frames. In one or more implementations, the listen duration 410 may be longer than the wakeup interval 409 (e.g., to account for slight differences in clock speed and other factors that might affect reception of wakeup frames at the edges of the listening window, and thereby to more reliably perform wakeup for the sleepy end devices). Responsive to receiving a wakeup frame 408, a sleepy end device may provide a response to the device from which its wakeup frame 408 was received, and perform connection setup operations with that device to reconnect to the mesh network 150 (e.g., to attach or re-attach to a parent device).

As shown in FIG. 4, the wakeup procedure discussed herein may be performed for maximum of a specific duration (e.g., End of Wakeup (Static) in FIG. 4) after an outage event, such as a router device reboot, a software update or a power outage event, or another wakeup trigger event (e.g., a sensor detection). For example, whether or not all of the sleepy end devices have been woken up by the static end-of-wakeup time period, the wakeup procedure may end. In one or more implementations, the wakeup procedure may also have a dynamic end-of-wakeup time, which may be earlier than the static end-of-wakeup time period, such as at a time at which a last one of the sleepy end devices has woken up.

In the example of FIG. 4, the wakeup frames 406 and 408 are transmitted asynchronously due to different random jitter times of the devices transmitting the wakeup frames (e.g., the routers 154), without specifically scheduling the transmission times from the various devices transmitting the wakeup frames (e.g., the routers 154). FIG. 5 illustrates another example, in which the wakeup frames are transmitted based on a schedule (e.g., a wakeup schedule). For example, a central coordinator (e.g., the leader 154L or a resident device) may synchronize the schedule for wakeup frame transmissions to avoid collisions. In one or more implementations, a schedule can be synchronized via new Type-Length-Value (TLV) or a modifications to an existing TLV in the Mesh Link Establishment (MLE) protocol.

In the example of FIG. 5, as in the example of FIG. 4, the wakeup frames 406 and 408 are transmitted for a wakeup duration 407 spaced apart from another wakeup duration 407 by a wakeup interval 409. However, in FIG. 5, the first router (e.g., a router 154 with a Router ID = n, such as a leader 154L) repeatedly transmits wakeup frames 406 (e.g., according to a schedule received from the coordinator) before the second router (e.g., another router 154 with a Router ID = n+1) repeatedly transmits its wakeup frames 408. In the example of FIG. 5, as in the example of FIG. 4, the wakeup procedure may end when all of the sleepy end devices have been woken up and performed connection setup operations to return to the mesh network 150 (e.g., at a dynamic end-of-wakeup time) or after a maximum period of time (e.g., the static end-of-wakeup time).

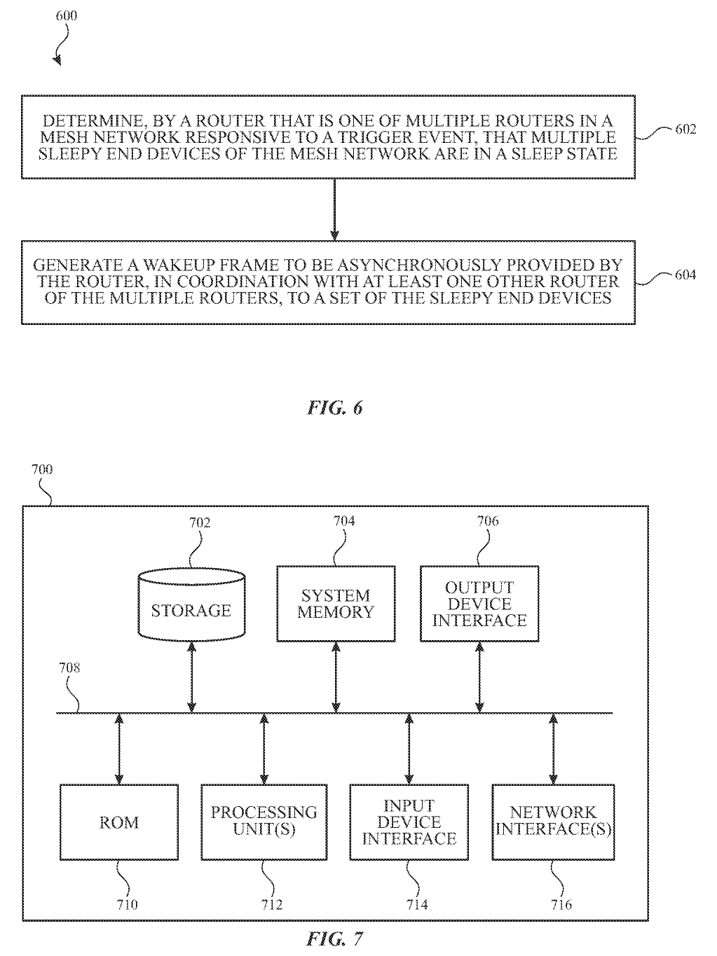

FIG. 6 is a flow chart of an example process 600 that may be performed for coordinated network wakeup in accordance with one or more implementations. For explanatory purposes, the process 600 is primarily described herein with reference to a router 154 of FIGS. 1 and 3. However, the process 600 is not limited to the router 154 of FIGS. 1 and 3, and one or more blocks (or operations) of the process 600 may be performed by one or more other components of other suitable devices and/or servers. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, a device (e.g., a router 154, such as a router having a router ID of n, where n is an integer) that is that is one of multiple routers in a mesh network (e.g., mesh network 150) may determine, responsive to a trigger event, that multiple sleepy end devices (e.g., end devices 152) of the mesh network are in a sleep state. For example, the trigger event may include an event (e.g., a router reboot, a software update, or a power outage) that renders the multiple routers unreachable by the multiple sleepy end devices for a period of time that results in at least two of the multiple sleepy end devices entering a prolonged sleep state or a detached state. As another example, a trigger event may include a security sensor (e.g., a camera, a motion sensor, or the like) of a network of security sensors (e.g., disposed around a perimeter of a geographical area), some of which are in a sleep state or detached state, detecting a potential intrusion event (e.g., a person or other object within the perimeter or moving toward or across the perimeter).

At block 604, the device may generate (e.g., responsive to the trigger) one or more wakeup frames (e.g., wakeup frame(s) 406) to be asynchronously provided, in coordination with at least one other router (e.g., another router, such as a router 154 having a router ID of n+1 or n+m, where m is an integer) of the multiple routers (e.g., using the unscheduled wakeup procedure of FIG. 4, or the scheduled wakeup procedure of FIG. 5), to a set of the sleepy end devices. For example, the set of the sleepy end devices may include a set of the sleepy end devices that were previously attached to the device as child devices of the device, and/or one or more sleepy end devices that are in a detached state (e.g., unattached to any parent device in the mesh network). The sleepy end devices that are in the detached state may have previously been attached to a parent device in the mesh network 150, or may never have been connected to the mesh network 150. In one or more implementations, the wakeup frame(s) includes a rendezvous time of zero. The wakeup frame(s) include a general wakeup frame that is provided to multiple sleepy end devices, or may include multiple wake up frames including wakeup frames that are addressed to specific sleepy end devices.

In one or more implementations, the device may set a first random jitter (e.g., jitter time 402 of FIG. 4) for asynchronously sending the wakeup frame(s) to the set of the sleepy end devices, the first random jitter different from a second random jitter (e.g., jitter time 404) set by the at least one other router (e.g., as in the example of FIG. 4). For example, setting the first random jitter may include setting the first random jitter based on (e.g., proportional to) an identifier (e.g., a numerical identifier value, such as n, n+1, etc.) of the device.

In one or more other implementations, the device may asynchronously provide the wakeup frame(s) to the set of the sleepy end devices according to a wakeup schedule for the router and the at least one other router (e.g., as in the example of FIG. 5). For example, prior to asynchronously providing the wakeup frame(s) according to the wakeup schedule, the device may receive the wakeup schedule from a coordinator (e.g., leader 154L or a resident device), such as via a different router of the multiple routers. As another example, the router may be a leader for the mesh network, and the process 600 may also include generating the wakeup schedule at the device, and providing the wakeup schedule to the at least one other router.

In one or more implementations, the device may asynchronously provide the wakeup frame(s) to the set of the sleepy end devices (e.g., as in the example of FIG. 4 or FIG. 5) until the earlier of a last one of the set of sleepy end devices being reconnected to the mesh network (e.g., a dynamic end-of-wakeup time) or a maximum wakeup period of time (e.g., a static end-of-wakeup time).

In one or more implementations, the process may also include receiving, by the device and responsive to asynchronously providing the wakeup frame(s) to the set of sleepy end devices, a set of asynchronous responses from the set of sleepy end devices, and performing, responsive to the set of asynchronous responses, a set of asynchronous connection setup operations for reconnecting the set of sleepy end devices to the mesh network.

FIG. 7 illustrates an electronic system 700 with which one or more implementations of the subject technology may be implemented. The electronic system 700 can be, and/or can be a part of, any one of the electronic devices 110 or 112, the end devices 152, the router 154, and/or the server 120 shown in FIG. 1. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a flash drive, and its corresponding solid-state drive) may be used as the permanent storage device 702. Like the permanent storage device 702, the system memory 704 may be a read-and-write memory device. However, unlike the permanent storage device 702, the system memory 704 may be a volatile read-and-write memory, such as random-access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710. From these various memory units, the one or more processing unit(s) 712 retrieves instructions to execute and data to process in order to execute the processes of one or more implementations.

The bus 708 also connects to the input device interface 714 and output device interface 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to one or more networks and/or to one or more network nodes, such as the electronic device 110 shown in FIG. 1, through the one or more network interface(s) 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “router”, “end device”, “transceiver”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
determining, by a router that is one of multiple routers in a mesh network responsive to a trigger event, that multiple sleepy end devices of the mesh network are in a sleep state; and
generating a wakeup frame to be asynchronously provided by the router, in coordination with at least one other router of the multiple routers, to a set of the sleepy end devices.

2. The method of claim 1, wherein the trigger event comprises an event that renders the multiple routers unreachable by the multiple sleepy end devices for a period of time that results in at least two of the multiple sleepy end devices entering a prolonged sleep state or a detached state.

3. The method of claim 2, wherein the trigger event comprises at least one of: a router reboot, a software update, a power outage, or a sensor detection.

4. The method of claim 1, further comprising setting, by the router, a first random jitter for asynchronously sending the wakeup frame to the set of the sleepy end devices, the first random jitter different from a second random jitter set by the at least one other router.

5. The method of claim 4, wherein setting the first random jitter comprises setting the first random jitter based on an identifier of the router.

6. The method of claim 1, further comprising asynchronously providing the wakeup frame to the set of the sleepy end devices according to a wakeup schedule for the router and the at least one other router.

7. The method of claim 6, further comprising, prior to asynchronously providing the wakeup frame according to the wakeup schedule, receiving the wakeup schedule from a coordinator via a different router of the multiple routers.

8. The method of claim 6, wherein the router is a leader for the mesh network, and wherein the method further comprises:
generating the wakeup schedule at the router; and
providing the wakeup schedule to the at least one other router.

9. The method of claim 1, wherein the wakeup frame includes a rendezvous time of zero.

10. The method of claim 1, further comprising asynchronously providing the wakeup frame to the set of the sleepy end devices until the earlier of:
a last one of the set of sleepy end devices being reconnected to the mesh network; or
a maximum wakeup period of time.

11. The method of claim 1, further comprising:
receiving, responsive to asynchronously providing the wakeup frame to the set of sleepy end devices, a set of asynchronous responses from the set of sleepy end devices; and
performing, responsive to the set of asynchronous responses, a set of asynchronous connection setup operations for reconnecting the set of sleepy end devices to the mesh network.

12. A device, comprising:
one or more processors configured to:
operate the device as a first router of multiple routers in a mesh network, at least in part by:
determining, responsive to a trigger event, that multiple sleepy end devices of the mesh network are in a sleep state; and
generating a wakeup frame to be asynchronously provided by the device, in coordination with at least a second router of the multiple routers, to a set of the sleepy end devices.

13. The device of claim 12, further comprising setting a first random jitter for asynchronously sending the wakeup frame to the set of sleepy end devices, the first random jitter different from a second random jitter set by at least the second router.

14. The device of claim 13, wherein the first random jitter is based on an identifier of the first router.

15. The device of claim 12, further comprising providing the wakeup frame for asynchronous transmission to the set of sleepy end devices according to a wakeup schedule for the first router and at least the second router.

16. The device of claim 15, wherein the one or more processors are further configured to, prior to providing the wakeup frame for asynchronous transmission according to the wakeup schedule, receive the wakeup schedule from a coordinator via a third router of the multiple routers.

17. The device of claim 16, wherein the first router is a leader for the mesh network, and wherein the one or more processors are further configured to:
generate the wakeup schedule; and
provide the wakeup schedule for transmission to at least the second router.

18. The device of claim 12, wherein the wakeup frame includes a rendezvous time of zero.

19. The device of claim 12, further comprising providing the wakeup frame for asynchronous transmission to the set of the sleepy end devices for at most a maximum period of time.

20. A non-transitory computer readable medium storing instructions which, when executed by one or more processors, cause the one or more processors to perform operations comprising:
determining, responsive to a trigger event, that multiple sleepy end devices of a mesh network are in a sleep state, the mesh network comprising multiple routers; and
generating a wakeup frame to be asynchronously provided, in coordination with at least one router of the multiple routers, to a set of the sleepy end devices.
